(19) United States
(12) Patent Application Publication
(10) Pub. No.: US 2025/0019630 A1
(43) Pub. Date: Jan. 16, 2025

(54) DE-ALCOHOLISATION METHOD AND DEVICE, AND USES THEREOF

(71) Applicant: W CE PROCESS, BORDEAUX (FR)

(72) Inventor: Jean-Philippe RICARD, BORDEAUX (FR)

(21) Appl. No.: 18/716,378

(22) PCT Filed: Dec. 7, 2022
(86) PCT No.: PCT/EP2022/084742

§ 371 Date: Jul. 3, 2024

(30) Foreign Application Priority Data
Dec. 8, 2021 (FR) FR2113132

(51) Int. Cl. C12H 3/02; B01D 1/28; B01D 3/00

(52) U.S. Cl. CPC C12H 3/02; B01D 1/28; B01D 3/001

(57) ABSTRACT

The present invention relates to a method for the de-alcoholization of potable alcohol, a device for carrying out said method, and to the uses thereof.

### TECHNICAL FIELD

The invention relates to a method for dealcoholizing potable alcohol, a device for carrying out said method, and to the uses thereof.

### PRIOR ART

In recent years, the share of consumers buying alcoholic or high-alcohol beverages has been steadily declining, in favor of non-alcoholic or lower-alcohol beverages.

There is also growing demand for such beverages from consumers and, incidentally, from industry professionals. However, making low-alcohol or alcohol-free beverages is a delicate exercise which often affects the quality of the beverage and, in particular, the flavors it contains.

On the other hand, the climate upheavals we are experiencing today tend to naturally increase the alcohol content of potable spirits, including wines. Indeed, the increasingly sunny climate with periods of drought favors an increase in sugar levels, particularly in grapes, and consequently an increase in the alcohol content of the wine.

This can be remedied by bringing the harvest forward or optimizing alcoholic fermentation. As a result, numerous methods for dealcoholizing potable spirits have been developed in recent years to reduce or eliminate alcohol content.

Prior art de-alcoholization method essentially rely either on the upstream selection of low-sugar grape varieties, or on the downstream selection of the finished product, such as wine.

Methods for dealcoholizing the finished product are known, such as vacuum distillation, which aims to extract the flavors and then the alcohol, before reintroducing the extracted flavors. Also of note are reverse osmosis de-alcoholization methods, which eliminate the mixture of water and alcohol, and spinning cone column methods, widely used in Australia and the USA, which aim to remove flavors and then de-alcoholize by stripping the steam obtained under vacuum, before reintroducing the flavors into the finished wine.

The majority of methods known to date are based on treatment of the finished product, such as finished wine. However, such methods are cumbersome, complex, and costly to implement, and involve an inevitable loss of some of the flavors contained in the wine, or even harm the structure of the wine.

There is therefore a need for a new de-alcoholization process that overcomes the disadvantages of the prior art, in particular reducing or eliminating the alcohol content without loss of flavor while avoiding the need to install new devices that are costly and complex for the winemaker.

### SUMMARY OF THE INVENTION

To meet this need, the invention proposes a new method for de-alcoholizing a potable alcohol which takes place during the alcoholic fermentation process, for example during the winemaking process, and not on a finished product as described in the prior art.

The inventors, when cooling vapors containing CO₂, said vapors having resulted from wine fermentation, such as alcoholic fermentation, surprisingly discovered significant condensation of both flavors and alcohols. The inventors have thus demonstrated significant evaporation of the alcohols accompanying the CO₂ during alcoholic fermentation.

The inventors have thus implemented a new de-alcoholization method which aims to maintain or even increase the circulation of CO₂ during the fermentation process. The aim is to increase the evaporation of at least some of the alcohol contained in the potable alcohol during fermentation, and then to eliminate this alcohol from the vapors released, thereby reducing the alcohol content of the finished product.

Such a method is particularly useful in the context of the invention and overcomes the disadvantages of the prior art, as it enables the CO₂ naturally emitted during alcoholic fermentation to be used by means of the fermentation tank to remove the water, alcohol, and flavors that accompany the CO₂. Also, no exogenous CO₂ is added during the process.

Thus, the invention relates to a method for de-alcoholizing a potable alcohol in an alcoholic fermentation tank comprising the following steps:
a. Recovering vapors emitted during alcoholic fermentation, comprising CO₂, water, alcohol and flavors, through the outlet of said tank,
b. Compressing the vapors recovered in step a. using a compressor,
c. Condensing the vapors compressed in step b. by means of a condenser,
d. Separating the gas and liquid contained in the mixture obtained in step c. by means of a gas/liquid separator and removing a condensate via the liquid outlet, and
e. Recovering and reinjecting at least some of the CO₂ extracted in step d. by means of a gas injector comprising flow control means.

According to one variant, the method according to the invention is implemented by means of a group of tanks in each of which alcoholic fermentation and consequently CO₂ emission take place. The tanks are then connected to each other by means of connectors upstream of the compressor.

In another variant, the CO₂ comes from a storage tank. The CO₂ contained in said storage tank may or may not be the result of alcoholic fermentation, and may also be connected upstream of the compressor, for example between the fermentation tank and the compressor, or downstream of the compressor, for example between the separator and the gas injector. In this way, the method according to the invention can be implemented either continuously or in batch mode.

According to another aspect, the invention relates to a potable alcohol de-alcoholizing device for implementing the method according to the present invention comprising:
an alcoholic fermentation tank comprising an outlet forming an upper end of said tank and an inlet forming a lower end of said tank, said outlet comprising a valve, and
a compressor adapted to be mounted on the outlet, said compressor comprising an outlet, and
a condenser adapted to be mounted on said compressor outlet, said condenser comprising an outlet, and
a gas/liquid separator adapted to be mounted on the condenser outlet, said separator comprising a gas outlet and a liquid outlet, and
a gas injector configured to be mounted between the gas/liquid separator outlet and the tank inlet.

Finally, according to a last aspect, the invention concerns the use of CO₂ from alcoholic fermentation of potable alcohols to reduce the alcohol content of said potable alcohols.

Further features and advantages will become apparent from the detailed description of the invention and the FIGURES, which are illustrative only and by no means limit the scope of the invention.

### BRIEF DESCRIPTION OF THE FIGURES

FIG. 1 schematically shows a device comprising a fermentation tank according to one embodiment of the invention.

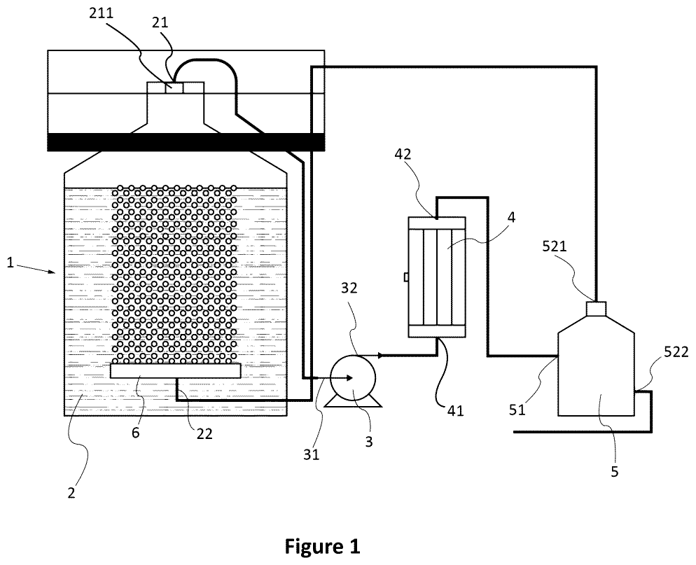

### DETAILED DESCRIPTION OF THE INVENTION

### Definition

For the purposes of this invention, “potable alcohol” refers to alcohol produced by distillation of sweetened or saccharified vegetable matter, used in particular in the production of alcoholic beverages such as spirits or wine. Preferentially, the potable alcohol is selected from liqueur, armagnac, cognac and wine. More preferentially, the potable alcohol is wine, including white, rosé or red wines.

For the purposes of the invention, “atmospheric pressure” means a pressure equal to 1.01325 bar (plus or minus 0.1 bar), that is, a pressure between 0.91325 and 1.11325 bar.

For the purposes of the invention, “condensate” refers to the mixture obtained at the end of step d., that is, the liquid mixture separated from the CO₂ obtained after the separation step, said condensate comprising water, alcohol and flavors.

By “vapors” in the sense of the invention, we mean a gaseous mixture comprising at least CO₂, water, alcohol and flavors.

### Method and Device According to the Invention

The object of the present invention is therefore a method for dealcoholizing a potable alcohol in an alcoholic fermentation tank 2 comprising the following steps:
a. Recovering at least part of the vapors comprising CO₂, water, alcohol and flavors, emitted during alcoholic fermentation by means of outlet 21 of said tank,
b. Compressing the vapors recovered in step a. using a compressor 3,
c. Condensing the vapors compressed in step b. by means of a condenser 4,
d. Separating the gas and liquid contained in the mixture obtained in step c. by means of a gas/liquid separator 5 and removing a condensate via the liquid outlet 522, and
e. Recovering and reinjecting at least some of the CO₂ extracted in step d. by means of a gas injector 6 comprising flow control means.

During alcoholic fermentation in an alcoholic fermentation tank, or possibly a group of fermentation tanks, the sugars present in the must are transformed into alcohol and carbon dioxide (CO₂) by microorganisms, notably yeasts, also present in the must. CO₂ is then removed from the process by means of an outlet forming an upper end of said fermentation tank. All or some of the CO₂ emitted is thus eliminated into the atmosphere, or stored in a CO₂ storage tank. Said storage tank may be under atmospheric pressure or sub-atmospheric pressure. Said storage tank can be located upstream or downstream of the compressor.

In the context of the present invention, the inventors have discovered that CO₂ vapors comprise not only CO₂, but also water, alcohol and flavors. Thus, the vapors emitted during alcoholic fermentation are recovered by means of the outlet 21 of said fermentation tank 2. These vapors comprise CO₂, but also water, alcohols, and flavors. Preferentially, the outlet 21 comprises a valve 211 configured to recover all or some of the vapors and eliminate the residual part of the vapors, for example if vapors are emitted in excessively large quantities.

Thus, according to a preferred object of the invention, during step a. of the method, at least one part of the vapors comprising CO₂, water, alcohol and flavors emitted during alcoholic fermentation are recovered by means of outlet 21 and a 2^{nd} part is eliminated by means of a valve 211, said valve 211 is configured so that the pressure in the tank 2 is equal to atmospheric pressure.

Alternatively, said valve 211 is configured so that the pressure in tank 2 is higher than atmospheric pressure, preferentially between 1 and 7 bar, more preferentially between 1 and 6 bar.

Advantageously, the method according to the invention is implemented by means of a so-called dynamic system, that is, the vapors comprising CO₂, water, alcohol and flavors, resulting from fermentation by means of a fermentation tank 2 or a group of tanks, for example at least 2 fermentation tanks, are immediately treated and recycled by means of a compressor 3, a condenser 4, a gas/liquid separator 5 and an injector 6. The method is then run continuously.

When the method is run in batch mode, it may comprise a CO₂ storage step using a CO₂ storage tank, located, for example, between the separator 5 and the gas injector 6. The stored CO₂ can then be re-injected when necessary, for example at the end of fermentation when the quantity of CO₂ naturally emitted is too low to obtain a satisfactory quantity of CO₂ re-injected into the fermentation tank 2.

After recovery of at least some, preferentially all, of the vapors released during the fermentation process, they are compressed in step b. by means of a compressor 3. The compressor 3 preferentially comprises an inlet 31 configured to connect to the outlet 21 of the fermentation tank 2 and an outlet 32 configured to connect to inlet 41 of the condenser 4.

Compression step b, thus aims to compress the vapors from fermentation tank 2, thereby increasing the efficiency of CO₂ recycling in tank 2. Preferentially, the CO₂ is compressed in step b. to a value of between 1.1 and 4 bar, more preferentially between 1.3 and 2.5 bar, to counteract downstream pressure due to the condenser.

According to a preferred object, the compressor 3 is selected from a dry compressor, a liquid ring compressor and a hydro-ejector. More preferentially, the compressor 3 is a hydro-ejector or a liquid ring compressor.

According to another preferred design, the compressor 3 comprises a pressure control means at the output, enabling the compression ratio to be adjusted and preventing air from being sucked in.

After the compression stage, the vapors are condensed to obtain cooled “dry” CO₂ and a liquid mixture comprising water, alcohol, and flavors. The condensation step c. is thus implemented by means of a condenser 4, enabling the “dry” CO₂ to be recycled, that is, not comprising the liquid mixture (water, alcohol, flavors), so that the said “dry” CO₂ is loaded with the said liquid mixture as it passes back into the tank 2. The compressor 4 preferentially comprises an inlet 41 configured to connect to the outlet 32 of the fermentation tank 3 and an outlet 42 configured to connect to the inlet 51 of the gas/liquid separator 5.

Preferentially, the condenser 4 is selected from a cooler or a heat exchanger. More preferentially, the condenser 4 is a plate or tubular exchanger.

Preferentially, in step c., the vapors compressed in step b. are condensed at a temperature of between 4 and 15° C., more preferentially at a temperature of between 4 and 12° C. A temperature below 12° C. enables water, alcohol and flavor vapors to be condensed and CO₂ to be cooled to a very low temperature without forming frost, while maximizing condensation of water, alcohol and flavor vapors.

At the end of step c., CO₂ is obtained in gaseous form and a mixture is obtained in liquid form comprising water, alcohols and flavors. Said liquid mixture and the CO₂ obtained in step c. can then be separated in step d.

Step d, thus involves separating the liquid mixture from the CO₂ using a gas/liquid separator 5. Said gas/liquid separator 5 comprises at least one outlet, preferentially consisting of a gas outlet 521 and a liquid outlet 522. Said outlet 521 is preferentially configured to be connected to inlet 61 of gas injector 6 in order to reinject CO₂ extracted from vapors.

Preferentially, the gas/liquid separator 5 is selected from a cylindrical, cyclonic and demisting gas/liquid separator. More preferentially, the gas/liquid separator 5 is a demister.

At the end of step d., a condensate is obtained, i.e. a mixture comprising water, alcohol and flavors separated from the gas, that is to say “dry” CO₂. The said mixture of water, alcohol and flavor can then be removed or possibly stored by means of a condensate storage tank, preferentially this is removed or stored by means of the liquid outlet 522,

The CO₂ can be stored in a CO₂ storage tank or re-injected into the fermentation tank 2 by means of a gas injector 6 comprising flow control means. Preferentially, said gas injector 6 is configured to be mounted between the outlet 521 of the gas/liquid separator and the inlet 22 of the fermentation tank 2 or after the outlet 521 inside the tank 2.

Preferentially, the injector 6 is configured so that CO₂ is re-injected at the lower end of the fermentation tank 2 inlet, thereby improving the efficiency of the de-alcoholization method by increasing the residence time of the CO₂ in the tank 2. By maximizing the residence time in tank 2, the contact between the CO₂ and the potable alcohol is increased, thus improving the loading of the “dry” CO₂ with the liquid mixture and thus improving yield.

Preferentially, the injector 6 is selected from a fine-bubble plate diffuser, a fine-bubble tube diffuser, and a fine-bubble disc, mushroom or sintered diffuser. More preferentially, the injector 6 is a fine-bubble plate diffuser or a fine-bubble tube diffuser or a fine-bubble mushroom diffuser.

According to a particularly preferred embodiment, CO₂ is re-injected during step e. at a re-injection rate of between 1.3 and 40 times, preferentially between 2 and 40 times, the CO₂ production naturally produced during fermentation, further improving the efficiency of the de-alcoholization method.

Thus, the quantity of CO₂ recycled or reintroduced by means of a gas injector 6 corresponds to at least 2 times the quantity of CO₂ naturally emitted during fermentation in the fermentation tank 2, preferentially between 2 and 40 times, more preferentially the re-injection rate is between 10 and 30, even more preferentially the re-injection rate is between 15 and 25.

Particularly preferred, the re-injection rate is equal to 20. By way of example, a re-injection rate of 20 results in a 2° reduction in alcohol content.

The re-injection rate, that is to say the flow of CO₂ re-injected into the tank by means of a gas injector 6, said injector 6 is configured either manually or automatically.

Advantageously, step e. is carried out either continuously or in batch mode. When it is continuous, CO₂ is re-injected via an injector 6, and any excess CO₂ is removed. When step e. is carried out in batch mode, the CO₂ is stored in a CO₂ storage tank.

Said CO₂ storage tank is configured so that the CO₂ is kept at a pressure below atmospheric pressure. Preferentially, said CO₂ storage tank is configured so that the CO₂ is kept at a pressure equal to the outlet pressure of compressor 3.

According to one variant, step e. is carried out during alcoholic fermentation or after alcoholic fermentation during maceration or during malolactic fermentation. Preferentially, step e. is carried out during alcoholic fermentation.

According to a particularly preferred embodiment, the potable alcohol is wine.

Thus, according to another aspect, the invention also relates to a potable alcohol de-alcoholization device 1 comprising:
an alcoholic fermentation tank 2 comprising an outlet 21 forming an upper end of said tank and an inlet 22 forming a lower end of said tank, said outlet 21 comprising a valve 211, and
a compressor 3 adapted to be mounted on the outlet 21, said compressor comprising an outlet 32, and
a condenser 4 adapted to be mounted on said compressor 3 outlet 32, said condenser 4 comprising an outlet 42, and
a gas/liquid separator 5 adapted to be mounted on the condenser outlet 42, said separator 5 comprising a gas outlet 521 and a liquid outlet 522, and
a gas injector 6 configured to be mounted between the gas/liquid separator outlet 521 and the tank inlet 22.

Preferentially, the invention relates to a potable alcohol de-alcoholization device 1 for implementing the method according to the invention comprising:
an alcoholic fermentation tank 2 comprising an outlet 21 forming an upper end of said tank and an inlet 22 forming a lower end of said tank, said outlet 21 comprising a valve 211, and
a compressor 3 adapted to be mounted on the outlet 21, said compressor comprising an outlet 32, and
a condenser 4 adapted to be mounted on said compressor 3 outlet 32, said condenser 4 comprising an outlet 42, and
a gas/liquid separator 5 adapted to be mounted on the condenser outlet 42, said separator 5 comprising a gas outlet 521 and a liquid outlet 522, and
a gas injector 6 configured to be mounted between the gas/liquid separator outlet 521 and the tank inlet 22.

### Use

According to a last aspect, the invention concerns the use of CO2 from alcoholic fermentation of potable alcohols to reduce the alcohol content of said potable alcohols.

Preferentially, the alcohol content is reduced by 1 to 2°.

1. A method for dealcoholizing a potable alcohol in an alcoholic fermentation tank (2) comprising the following steps:
a. Recovering vapors emitted during alcoholic fermentation, comprising CO₂, water, alcohol and flavors, through the outlet of said tank,
b. Compressing the vapors recovered in step a. using a compressor,
c. Condensing the vapors compressed in step b. by means of a condenser,
d. Separating the gas and liquid contained in the mixture obtained in step c. by means of a gas/liquid separator and removing the condensate via the liquid outlet, and
e. Recovering and re-injecting at least some of the CO₂ extracted in step d. by means of a gas injector comprising flow control means.

2. The method according to claim 1, wherein the potable alcohol is wine.

3. The method according to claim 1, characterized in that CO2 is re-injected in step e. at a re-injection rate of between 2 and 40 times the CO2 production naturally produced during fermentation.

4. The method according to claim 3, wherein the re-injection rate is between 10 and 30.

5. The method according to claim 4, wherein the re-injection rate is between 15 and 25.

6. The method according to claim 5, wherein the re-injection rate is equal to 20.

7. The method according to claim 1, wherein one part of the CO2 emitted during alcoholic fermentation is recovered by means of the outlet (21) and a 2^{nd} part is eliminated by means of a valve (211), said valve (211) is configured so that the pressure in the tank (2) is equal to atmospheric pressure.

8. The method according to claim 1, wherein the CO2 part is eliminated into the atmosphere, or kept in a storage tank.

9. The method according to claim 1, wherein the compressor is selected from a dry compressor, a liquid ring compressor and a hydro-ejector.

10. The method according to claim 1, wherein the CO2 is compressed to between 1.1 and 4 bar.

11. The method according to claim 1, wherein the CO2 is compressed to between 1.3 and 2.5 bar.

12. The method according to claim 1, wherein the condenser is selected from a cooler or a heat exchanger.

13. The method according to claim 1, wherein the compressed CO2 is condensed in step c. at a temperature of between 4 and 15° C.

14. The method according to claim 13, wherein the temperature is between 4 and 12° C.

15. The method according to claim 1, wherein the gas/liquid separator is selected from cylindrical, cyclonic or demisting.

16. The method according to claim 1, wherein the liquid obtained at the end of step d. is a mixture of water, alcohol and flavor.

17. The method according to claim 1, wherein the injector is selected from a fine-bubble plate diffuser, a fine-bubble tube diffuser and a fine-bubble disc, mushroom or sintered diffuser.

18. The method according to claim 1, wherein step e. is carried out continuously or in batch mode.

19. The method according to claim 1, wherein step e. is carried out during alcoholic fermentation or after alcoholic fermentation during maceration or during malolactic fermentation.

20. A potable alcohol de-alcoholization device (1) for carrying out the method of claim 1 comprising:
an alcoholic fermentation tank (2) comprising an outlet (21) forming an upper end of said tank and an inlet (22) forming a lower end of said tank, said outlet (21) comprising a valve (211), and
a compressor (3) adapted to be mounted on the outlet (21), said compressor comprising an outlet, and
a condenser (4) adapted to be mounted on said compressor (3) outlet, said condenser comprising an outlet, and
a gas/liquid separator (5) adapted to be mounted on the condenser outlet, said separator (5) comprising a gas outlet (521) and a liquid outlet (522), and
a gas injector (6) configured to be mounted between the gas/liquid separator outlet (521) and the tank inlet (22).
